(19) United States
(12) Patent Application Publication
(10) Pub. No.: US 2003/0070972 A1
(43) Pub. Date: Apr. 17, 2003

(54) Soil covered environmentally affirmative household sewage treatment system

(76) Inventor: Jung Yong Kim, Buk-Ku (KR)

Correspondence Address: Eugene Oak Ph., D., J. D.,, Patent Attorney, 610 S. Van Ness, Los Angeles, CA, 90005, US

(21) Appl. No.: 09/976,904

(22) Filed: Oct. 15, 2001

(51) Int. Cl. C02F 3/06

(52) U.S. Cl. 210/170

(57) ABSTRACT

A soil treatment system eliminates organic impurities such as hydrocarbons, nitro compounds, and phosphorous compounds from a household sewage. The structure of this invention consists of including but not limited to decanting and denitrification bath, primary oxidation bath, decanting bath, secondary oxidation bath, and partial recycling pipes. Microorganisms living in the local soil facilitate denitrification and oxidation of a household sewage. The roots of grass covering the top surface of the reaction baths absorb and utilize water, impurities, and decomposed compounds as fertilizer. Unit bath for those steps consists of sewage bath, grids, and stone chips layer. Top of the stone chips layer is covered with available local soil. Local grass and flowers are planted on the soil. No artificial chemicals or specific bacteria are utilized. Effluent from this soil treatment system is odorless, colorless, and adequate to be used as living water such as sprinkler water, toilet, and car washing water. Baths buried under the ground and covered with normal garden vegiterians and flowers endow environmetally pleasant view.

The present invention relates to an environmentally affirmative structure decomposing hydrocarbons, nitro compounds, and phosphorous compounds in a household sewage with vegiterian, plants and micro organisms living in local soil. All structures are buried underground and covered with grass and flowers to provide a pleasant view.

### BACKGROUND OF THE INVENTION

1. Field of Invention

The present invention relates to a more environmentally affirmative structure for treating household sewages. Aerobic and anaerobic bacteria living in the local soil decompose hydrocarbons, nitro-compounds, and phosphorous compounds in a household sewage. Worms living in the soil digest these decomposed harmful material. Grass and flowers covering the reaction bath along with microorganisms and worms biologically decompose these harmful materials eventually to be used as fertilizer.

2. Description of the Prior Art

Microorganisms and bacteria have been widely used for sewer treatment. Typical trearment scheme includes use of primary settlers, bio filters, aeration tanks and secondary settlers.

U.S. Pat. No. 6,217,759 to Kolesnikov, et al. teaches of a device for biochemical sewage treatment, containing biocoagulators to provide oxidation of the sewage nitrogen compounds utilizing bio stimulating effect of a He—Ne laser (HNL).

U.S. Pat. No. 6,200,472 to Donald, et al. illustrates a use of single ‘Three Stage Sewage Treatment System’ made of fiberglass-reinforced plastics. The effluents from the process are chlorinated and stored for discharge.

U.S. Pat. No. 6,177,007 to Lee, et al. teaches to install plurality of aerobic and anaerobic tanks, communicating each other to minimize the sludge wash out from anaerobic tank.

U.S. Pat. No. 5,843,305 to Kim, et al. teaches to provide a media in a honeycomb type layer arrangement for even distribution of water and sewage, for effective adherence of microorganisms. Microorganisms activating at ambient temperature ranges were selected for commercial applications.

In all of the previous technology, bacteria were artificially embedded into a closed vessels equipped with vent lines. Appearances of those vessels are not environmentally pleasing as they appear as chemical plants.

### SUMMARY OF THE INVENTION

It is the object of this invention to provide a new small to medium size structure for treating household sewages more environmentally affirmative way providing a pleasant views.

FIG. 1 is a schematic representation of overall structure of this invention. All the reaction baths are buried underground. Garden vegetation and flowers are on the, soil covering the top layer, providing a pleasant view. Structure of this invention utilizes local soil, local stone chips and local plants for the microorganisms living in the area.

The structure emits no harmful gases, objectionable odors. The metabolic mechanism of the microorganisms in the local soil and photosynthesis of the plants on the soil accomplished the desired effect. Fresh oxygen, nitrogen, and moisture are the only gaseous emissions. The only aqueous effluent, water, from this structure is colorless and odorless enough to be used as household water for toilet, car washing and garden sprinkler.

The structure of this invention appears adequate for installation in a normal house yard.

### BRIEF DESCRIPTION OF THE DRAWINGS

FIG. 1 is a schematic representation of overall structure of this invention.

FIG. 2 is a schematic drawing showing structure materials, microorganism, plants, and their relationship within the system.

FIG. 3 is a schematic diagram of metabolic mechanisms of micro organisms and plants living in the system of this invention.

FIG. 4 is a perspective view of manhole barrier blocks.

### DETAILED DESCRIPTION OF THE PREFERRED EMBODIMENTS

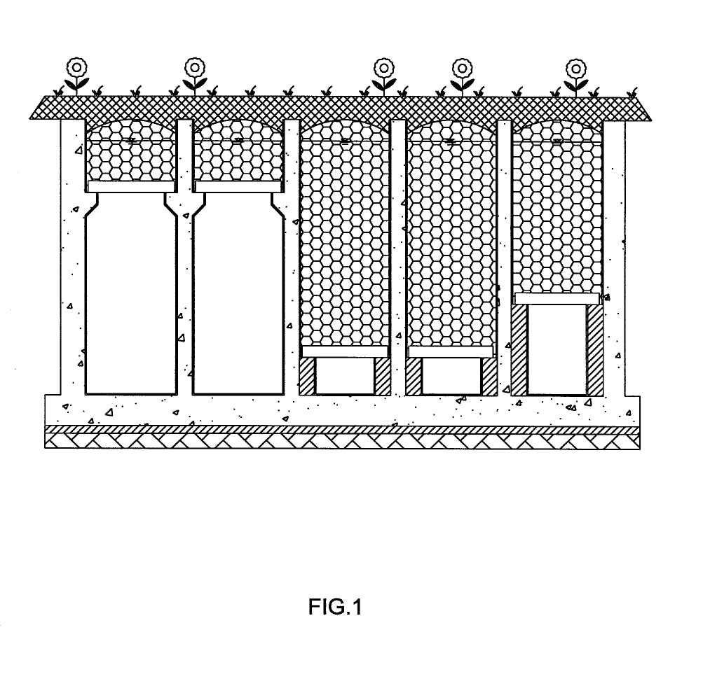

FIG. 1 is the schematic sketch of the structure of this invention. As shown in FIG. 1, the structure of this invention is buried underground. The grass and flowers cover the surface, providing a pleasant view.

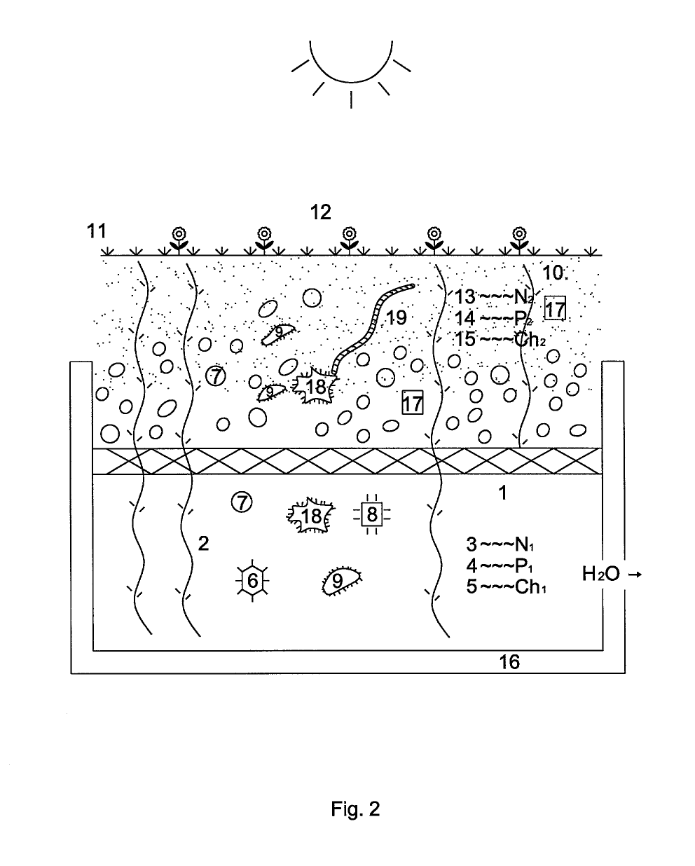

FIG. 2 is the schematic drawing showing structure materials, microorganism, plants and their relationship in the structure. When sewage (1) is introduced into the primary decanting and denitrification bath (16), the anaerobic microorganisms (6,7) living in the local soil and adhere to the roots (2) of the grass (11) and flowers (12) decompose the nitro compounds and produce nitrogen. Hydrocarbons are easily decomposed and digested by microorganisms (8) in the sewage and soil. Phosphorous compounds are digested by phosphorous accumulating organisms(PAOs) (9) in the aerobic bath (16). Protozoa (18) digest the PAOs and these protozoa are good food of the earthworm (19). Volatile compounds (13,14,15) from baths making objectionable odors are adsorbed onto the local soil (10) and decomposed by microorganisms (17) and become fertilizer for the plants.

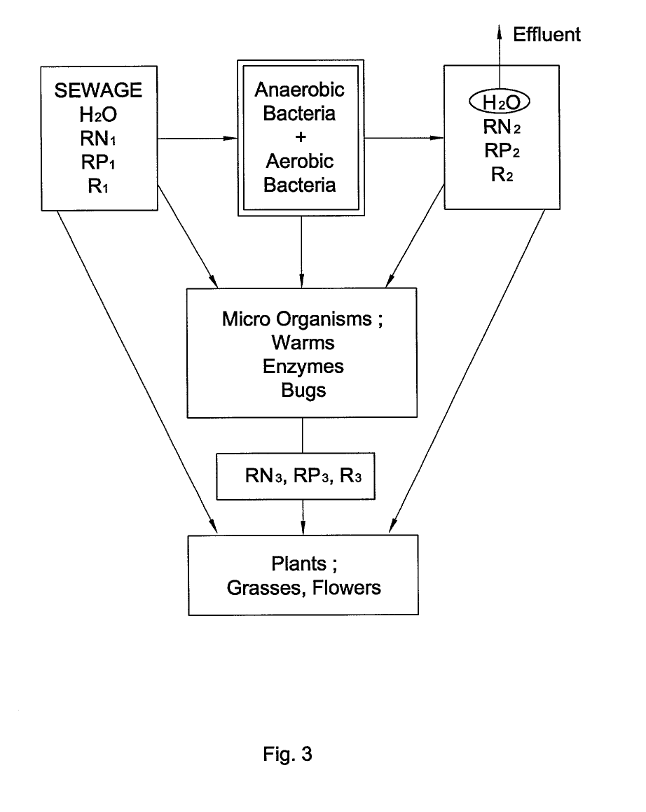

FIG. 3 is a schematic diagram of metabolic mechanisms of microorganisms and plants. All materials in the sewage can be used as fertilizer for the plants covering the top local soil while they are exposed to a decomposition step by the microorganisms in the baths. The first product from the decomposition steps are utilized as fertilizer for the grass. The earthworm and microorganisms in the soil digest the first products. Dead bodies of microorganisms are consumed as fertilizer for the plants.

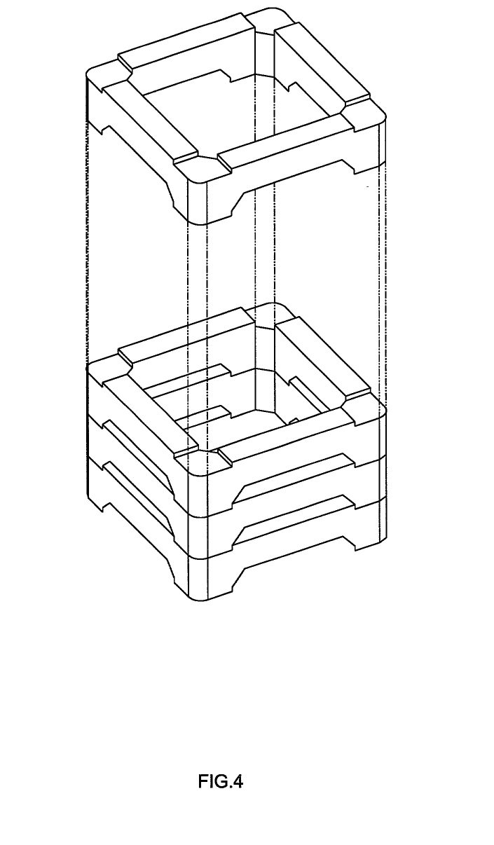

FIG. 4 is a perspective view of manhole barrier blocks for each reaction bath. The manhole block (600) has legs (602) and grooves (603). Simply piling up the blocks (600) makes baths between which the sewage can move freely through the void (604).

What is claimed is

1. An environmentally affirmative system for treatment of household sewage of BOD less than 500 ppm, having treatment capacity less than 100MT/day, geometrical volume in the range of 1 to 100 m³, consist of top layer planted with grasses and flowers in the area, the second top layer filled with the local soil with the depth of 1 m, the third layer from the top separated by the extended wall of each baths and filled with chips of stones and marbles of size of 10 to 50 mm in diameter, the bottom of the third layer from the top of the structure supported by grids.

2. The system in claim 1 consists of decanting and denitrification bath, primary oxidation bath, decanting bath, secondary oxidation bath, and partial recycling pipes.
